(19) United States
(12) Patent Application Publication
(10) Pub. No.: US 2024/0119118 A1
(43) Pub. Date: Apr. 11, 2024

(54) COMPUTER-READABLE RECORDING MEDIUM STORING SAMPLING PROGRAM, SAMPLING METHOD, AND INFORMATION PROCESSING APPARATUS

(71) Applicant: Fujitsu Limited, Kawasaki-shi (JP)

(72) Inventor: Yuma ICHIKAWA, Meguro (JP)

(73) Assignee: Fujitsu Limited, Kawasaki-shi (JP)

(21) Appl. No.: 18/353,243

(22) Filed: Jul. 17, 2023

(30) Foreign Application Priority Data
Sep. 29, 2022 (JP) 2022-155772

(51) Int. Cl. G06F 17/18

(52) U.S. Cl. CPC G06F 17/18

(57) ABSTRACT

A non-transitory computer-readable recording medium stores a program for causing a computer to execute a sampling process including: converting first data in a latent space into second data in a data space by using a machine learning model that has the latent space transformable into an isometric space with same probability distribution as the data space according to a predetermined transformation rule; determining whether or not to accept the second data as a transition state in a Markov chain Monte Carlo method from an accepted first sample in the data space with an acceptance probability based on the transformation rule; and outputting the second data as a second sample of the transition state from the first sample when the second data is determined to be accepted.

### CROSS-REFERENCE TO RELATED APPLICATION

This application is based upon and claims the benefit of priority of the prior Japanese Patent Application No. 2022-155772, filed on Sep. 29, 2022, the entire contents of which are incorporated herein by reference.

### FIELD

The embodiments discussed herein are related to a sampling program, a sampling method, and an information processing apparatus.

### BACKGROUND

By sampling using a computer, a specific sample may be obtained from probability distribution p(x) explicitly given by a mathematical formula. A Markov chain Monte Carlo method (MCMC) is one of sampling methods. The MCMC is a method of performing sampling from probability distribution by using Markov chain.

Akira Nakagawa, Keizo Kato, Taiji Suzuki, “Quantitative Understanding of VAE as a Non-linearly Scaled Isometric Embedding”, Proceedings of the 38th International Conference on Machine Learning, PMLR 139:7916-7926, 8-24 Jul. 2021, is disclosed as related art.

### SUMMARY

According to an aspect of the embodiments, a non-transitory computer-readable recording medium stores a program for causing a computer to execute a sampling process including: converting first data in a latent space into second data in a data space by using a machine learning model that has the latent space transformable into an isometric space with same probability distribution as the data space according to a predetermined transformation rule; determining whether or not to accept the second data as a transition state in a Markov chain Monte Carlo method from an accepted first sample in the data space with an acceptance probability based on the transformation rule; and outputting the second data as a second sample of the transition state from the first sample when the second data is determined to be accepted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary sampling method according to a first embodiment;

FIG. 2 is a diagram illustrating exemplary hardware of a computer;

FIG. 3 is a diagram illustrating a difference between a static Monte Carlo method and an MCMC;

FIG. 4 is a diagram for explaining a difference in efficiency of sampling by the MCMC;

FIG. 5 is a diagram illustrating a transition probability between states;

FIG. 6 is a diagram illustrating exemplary local proposal distribution;

FIG. 7 is a diagram illustrating exemplary improper sampling;

FIG. 8 is a diagram illustrating exemplary sampling by an SLMC;

FIG. 9 is a diagram illustrating exemplary sample generation by a VAE;

FIG. 10 is a block diagram illustrating exemplary computer functions for sampling by an IVAE-SLMC;

FIG. 11 is a flowchart illustrating an exemplary sample generation process;

FIG. 12 is a flowchart illustrating an exemplary sampling processing procedure by the IVAE-SLMC;

FIG. 13 is a flowchart illustrating an exemplary sample generation process according to a third embodiment;

FIG. 14 is a diagram illustrating exemplary parallel execution of the IVAE-SLMC;

FIG. 15 is a block diagram illustrating exemplary computer functions according to a fifth embodiment; and

FIG. 16 is a flowchart illustrating an exemplary procedure of a low-dimensional compression process.

### DESCRIPTION OF EMBODIMENTS

In recent years, the MCMC has been applied to a wide range of statistical problems centering on Bayesian statistics. For example, many-body problems that appear in physics commonly make analytical calculation impossible. In that case, properties of the many-body problems may be examined by sampling a physical system state using the MCMC. Furthermore, the MCMC has also been used in simulation of quantum calculation, which has been attracting attention recently. The MCMC may also be effectively used for a solution search of a Non-deterministic Polynomial time (NP)-hard optimization problem.

Moreover, the MCMC may also be used for the Bayesian statistics for data analysis. For example, in a case where data obtained by an experiment is applied to a certain effective model, sampling is carried out from posterior distribution according to Bayesian inference. The MCMC may be used for the sampling at this time.

In the sampling based on the MCMC, it is desirable to transition to a state different as much as possible from the immediately preceding sample state. As a technique for generating effective samples that may be regarded as independent from each other based on the MCMC, for example, there is a method of using a variational model appropriate for proposal probability distribution of a Metropolis method. The variational model does not refer to a previous state, and global transition is made possible. According to the global transition, efficiency in generation of effective samples that may be regarded as independent from each other improves. A machine learning model may be used as the variational model, and such a sampling method is called a self-learning Monte Carlo method (SLMC).

As the variational model based on the SLMC, for example, a machine learning model having a latent space is used. Examples of the SLMC using the machine learning model with a latent space include a method using a restricted Boltzmann machine (RBM) a method using a flow-based model, and a method using a variational autoencoder (VAE).

Note that quantitative understanding of characteristics is in progress for the VAE. For example, it has been found that the VAE may be mapped to an isometric embedding.

According to the existing SLMC using the machine learning model with a latent space, the efficiency in generation of effective samples that may be regarded as independent from each other is not sufficient. For example, the method using the RBM carries out the MCMC for probability distribution proposal, which needs high throughput. According to the method using the flow-based model, while the proposal cost of the probability distribution is small, strong constraints are imposed on the model to be used, resulting in low versatility. According to the method using the VAE, while the proposal cost of the probability distribution is small, approximate evaluation of a likelihood function is carried out so that approximation may not be appropriate. When the approximation is not appropriate, the acceptance probability is lowered, which causes deterioration in the sample generation efficiency.

In one aspect, an object of the present case is to improve efficiency in generation of effective samples that may be regarded as independent from each other.

Hereinafter, the present embodiments will be described with reference to the drawings. Note that each of the embodiments may be implemented in combination with a plurality of embodiments as long as no contradiction arises.

### First Embodiment

A first embodiment is a sampling method capable of improving efficiency in generation of effective samples that may be regarded as independent from each other.

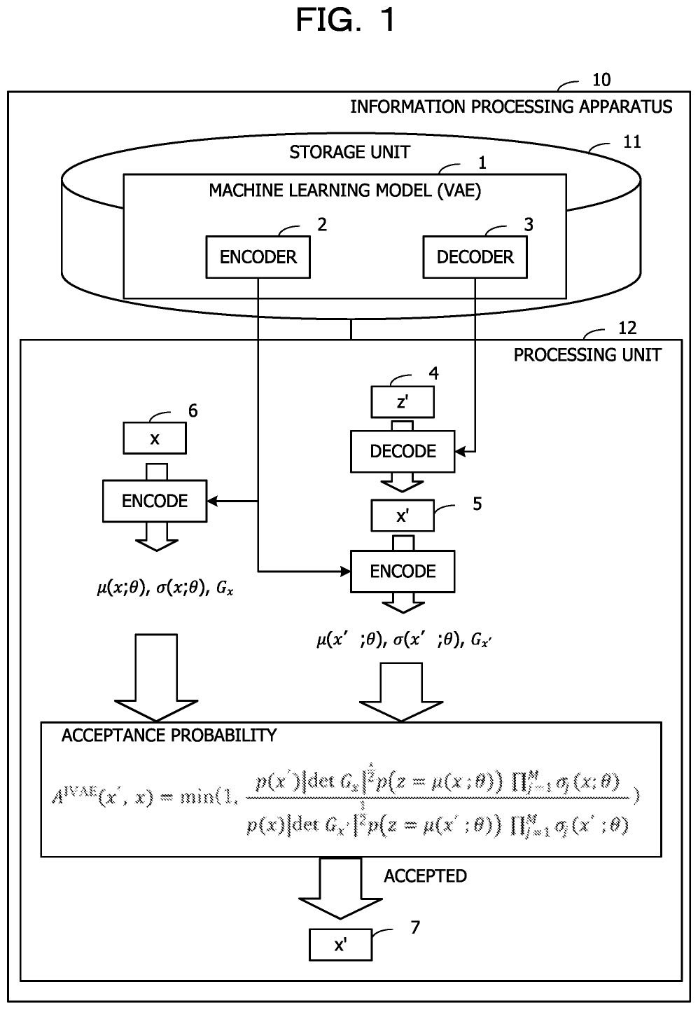

FIG. 1 is a diagram illustrating an exemplary sampling method according to a first embodiment. FIG. 1 illustrates an exemplary case where the sampling method according to the first embodiment is implemented by using an information processing apparatus 10. The information processing apparatus 10 may implement the sampling method by executing a sampling program, for example.

The information processing apparatus 10 includes a storage unit 11 and a processing unit 12. The storage unit 11 is, for example, a memory or a storage device included in the information processing apparatus 10. The processing unit 12 is, for example, a processor or an arithmetic circuit included in the information processing apparatus 10.

The storage unit 11 stores a machine learning model 1 having a latent space transformable into, according to a predetermined transformation rule, an isometric space with the same probability distribution as a data space.

The machine learning model 1 is, for example, a VAE. The VAE includes an encoder 2 and a decoder 3. The encoder 2 is a neural network that outputs a mean and a variance (or standard deviation) of data in the latent space when data in the data space is input. The decoder 3 is a neural network that outputs data in the data space when data in the latent space is input.

The transformation rule is, for example, non-linear mapping. When the machine learning model 1 is the VAE, the non-linear mapping is scaling (scale-up/scale-down) with values different for each dimension. The data space is a space that defines input data to the machine learning model 1. The latent space is a space that defines data to be generated in the machine learning model 1.

The processing unit 12 performs sampling based on the MCMC by using the machine learning model 1. For example, the processing unit 12 converts first data 4 in the latent space into second data 5 in the data space by using the machine learning model 1. For example, the processing unit 12 decodes the first data 4 with the decoder 3 of the VAE to generate the second data 5.

Next, the processing unit 12 probabilistically determines, with the acceptance probability based on the transformation rule, whether or not to accept the second data 5 as a transition state in the Markov chain Monte Carlo method from an accepted first sample 6 in the data space. For example, the processing unit 12 encodes the first sample 6 with the encoder 2 of the VAE to calculate a first mean value, a first variance, and a first metric tensor. Furthermore, the processing unit 12 encodes the second data 5 with the encoder 2 of the VAE to calculate a second mean value, a second variance, and a second metric tensor. Then, the processing unit 12 calculates the acceptance probability based on the first mean value, the first variance, the first metric tensor, the second mean value, the second variance, and the second metric tensor.

When it is determined to be accepted, the processing unit 12 outputs the second data 5 as a second sample 7 of the transition state from the first sample 6. Then, the processing unit 12 may perform sampling based on the MCMC by replacing the first sample 6 with the second sample 7 and repeating similar processing.

By performing sampling in this manner, it becomes possible to efficiently generate, as the second data 5, effective data that may be regarded as independent from data that has been already accepted, and to accept the second data 5 as the second sample 7 with a high acceptance probability. As a result, the efficiency in generation of effective samples that may be regarded as independent from each other improves.

The output second sample 7 may be used for training of the machine learning model 1. For example, in a case where the number of output second samples 7 is accumulated to some extent, the processing unit 12 trains the machine learning model 1 by using the output second samples 7. As a result, accuracy of the machine learning model 1 may be improved.

Furthermore, the processing unit 12 may execute the sampling process including the processing of conversion into the second data 5, the processing of probabilistically determining whether or not to accept the second data 5, and the processing of determining the second data 5 as the second sample 7 in parallel using each of a plurality of processors. In that case, the processing unit 12 carries out training of the machine learning model 1 by using the second sample 7 determined by each of the plurality of processors. As a result, accuracy of the VAE improves, and the efficiency in generation of effective samples that may be regarded as independent from each other improves.

### Second Embodiment

A second embodiment is a computer that implements an SLMC applicable to high-speed and complex distribution by utilizing the fact that a VAE, which is one of generation models, potentially has an isometric property. Here, potentially having the isometric property indicates including a latent space transformable into, according to a predetermined transformation rule, an isometric space with the same probability distribution as a data space representing input data.

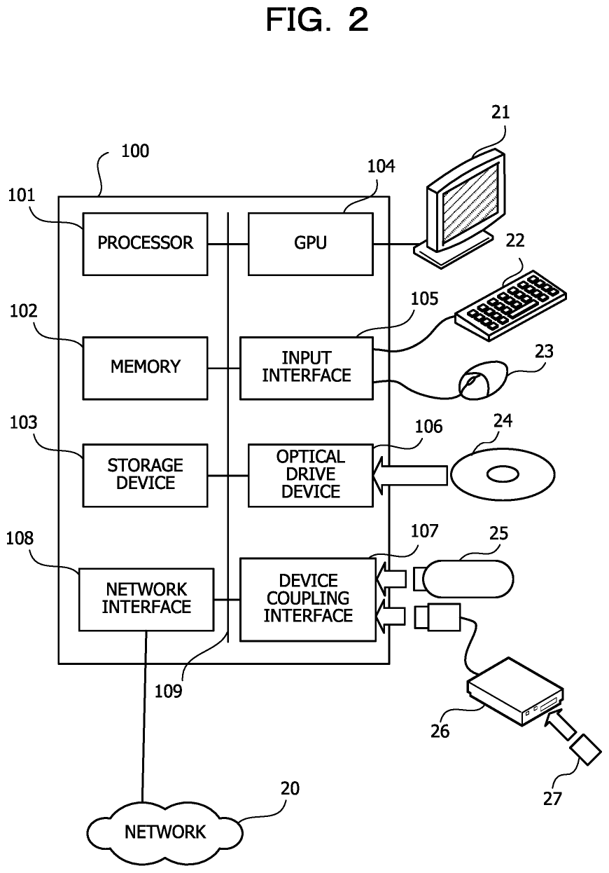

FIG. 2 is a diagram illustrating exemplary hardware of the computer. The entire device of a computer 100 is controlled by a processor 101. A memory 102 and a plurality of peripheral devices are coupled to the processor 101 via a bus 109. The processor 101 may be a multiprocessor. The processor 101 is, for example, a central processing unit (CPU), a micro processing unit (MPU), or a digital signal processor (DSP). At least some functions implemented by the processor 101 executing a program may be implemented by an electronic circuit such as an application specific integrated circuit (ASIC), a programmable logic device (PLD), or the like.

The memory 102 is used as a main storage device of the computer 100. The memory 102 temporarily stores at least a part of operating system (OS) programs and application programs to be executed by the processor 101. Furthermore, the memory 102 stores various types of data to be used in processing by the processor 101. As the memory 102, for example, a volatile semiconductor storage device such as a random access memory (RAM) is used.

Examples of the peripheral devices coupled to the bus 109 include a storage device 103, a graphics processing unit (GPU) 104, an input interface 105, an optical drive device 106, a device coupling interface 107, and a network interface 108.

The storage device 103 electrically or magnetically performs data writing and reading on a built-in recording medium. The storage device 103 is used as an auxiliary storage device of the computer 100. The storage device 103 stores OS programs, application programs, and various types of data. Note that, as the storage device 103, for example, a hard disk drive (HDD) or a solid state drive (SSD) may be used.

The GPU 104 is an arithmetic unit that performs image processing, and is also called a graphic controller. A monitor 21 is coupled to the GPU 104. The GPU 104 causes a screen of the monitor 21 to display an image in accordance with an instruction from the processor 101. Examples of the monitor 21 include a display device using organic electro luminescence (EL), a liquid crystal display device, and the like.

A keyboard 22 and a mouse 23 are coupled to the input interface 105. The input interface 105 transmits signals sent from the keyboard 22 and the mouse 23 to the processor 101. Note that the mouse 23 is an exemplary pointing device, and another pointing device may also be used. Examples of the another pointing device include a touch panel, a tablet, a touch pad, a track ball, and the like.

The optical drive device 106 uses laser light or the like to read data recorded in an optical disk 24 or write data to the optical disk 24. The optical disk 24 is a portable recording medium in which data is recorded to be readable by reflection of light. Examples of the optical disk 24 include a digital versatile disc (DVD), a DVD-RAM, a compact disc read only memory (CD-ROM), a CD-recordable (R)/rewritable (RW), and the like.

The device coupling interface 107 is a communication interface for coupling the peripheral devices to the computer 100. For example, a memory device 25 and a memory reader/writer 26 may be coupled to the device coupling interface 107. The memory device 25 is a recording medium equipped with a communication function with the device coupling interface 107. The memory reader/writer 26 is a device that writes data to a memory card 27 or reads data from the memory card 27. The memory card 27 is a card-type recording medium.

The network interface 108 is coupled to a network 20. The network interface 108 exchanges data with another computer or a communication device via the network 20. The network interface 108 is a wired communication interface coupled to a wired communication device such as a switch or a router with a cable, for example. Furthermore, the network interface 108 may be a wireless communication interface that is coupled to and communicates with a wireless communication device such as a base station or an access point with radio waves.

The computer 100 may implement processing functions of the second embodiment with the hardware as described above. Note that the device described in the first embodiment may also be implemented by hardware similar to that of the computer 100 illustrated in FIG. 2.

The computer 100 implements the processing functions of the second embodiment by executing, for example, a program recorded in a computer-readable recording medium. The program in which the processing contents to be executed by the computer 100 are described may be recorded in various recording media. For example, the program to be executed by the computer 100 may be stored in the storage device 103. The processor 101 loads at least a part of the program in the storage device 103 into the memory 102, and executes the program. Furthermore, the program to be executed by the computer 100 may also be recorded in a portable recording medium such as the optical disk 24, the memory device 25, or the memory card 27. The program stored in the portable recording medium may be executed after being installed in the storage device 103 under the control of the processor 101, for example. Furthermore, the processor 101 may also read the program directly from the portable recording medium and execute the program.

The computer 100 efficiently performs sample generation based on the SLMC using the VAE by effectively utilizing the property that the VAE potentially has the isometric property. Hereinafter, a sampling technique for performing the SLMC using the VAE by utilizing the property that the VAE potentially has the isometric property will be referred to as an IVAE-SLMC. On the other hand, a sampling technique for performing the SLMC using the VAE without utilizing the property that the VAE potentially has the isometric property will be referred to as a VAE-SLMC.

Hereinafter, the reason why efficient sampling is difficult in the VAE-SLMC will be described.

The VAE-SLMC is a form of an MCMC. Furthermore, the MCMC is a type of a Monte Carlo method. The Monte Carlo method is a generic term for a method of performing sampling from probability distribution p(x). In a broad sense, it is a generic term for a method of performing numerical calculation by using a random number. A Monte Carlo method that performs sampling from the probability distribution p(x) without using a Markov chain (stochastic process in which a current state depends only on an immediately preceding state) may be referred to as a static Monte Carlo method.

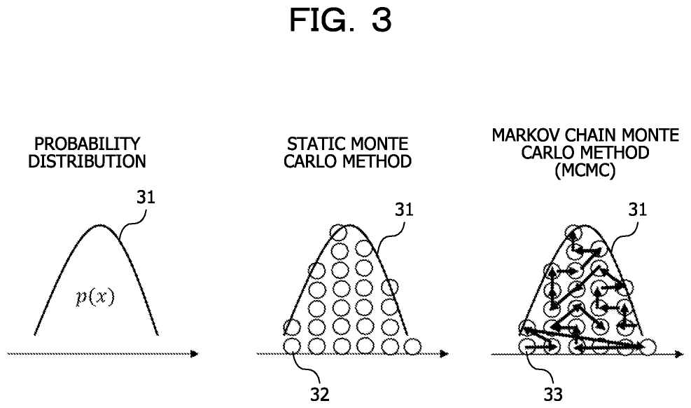

FIG. 3 is a diagram illustrating a difference between the static Monte Carlo method and the MCMC. In FIG. 3, the probability distribution p(x) is indicated by a curved line 31. In the static Monte Carlo method, a plurality of samples 32 is randomly generated according to the probability distribution p(x). By following the probability distribution p(x), more samples are generated as the probability is higher. In the Markov chain Monte Carlo method (MCMC), a plurality of samples 33 is generated by a stochastic process in which a current state (sample) depends only on an immediately preceding state (sample).

While more samples are generated as the probability in the probability distribution p(x) is higher in the MCMC as well, it is different from the static Monte Carlo method in that the samples are sequentially generated by the Markov chain. While sampling of high-dimensional probability distribution is difficult according to the static Monte Carlo method, the sampling of high-dimensional probability distribution may be performed according to the MCMC.

In order to efficiently perform sampling based on the MCMC, it is desirable to transition to a state different as much as possible from the immediately preceding state.

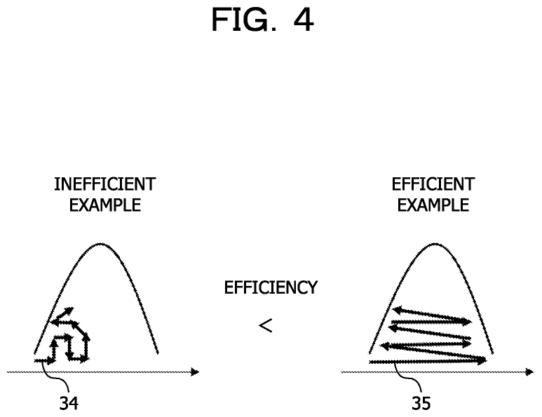

FIG. 4 is a diagram for explaining a difference in efficiency of sampling by the MCMC. It is important to be enabled to transition to a state different as much as possible from the immediately preceding state to improve the sampling efficiency. In a case where transition to a state different from the immediately preceding state may not be made (inefficient example), a large number of samples that may not be regarded as independent in which a distance between the individual samples is short are generated in a sample sequence 34. On the other hand, in a case where transition to a state different as much as possible from the immediately preceding state is made (efficient example), autocorrelation of a sample sequence 35 decreases, and the number of effective samples that may be regarded as independent increases. By performing efficient sampling based on the MCMC, it becomes possible to make transition of a state to the entire random variable space in a realistic time.

Meanwhile, in the Markov chain that converges to the target probability distribution, a transition probability w(X′|X) from a certain state X to another state X′ needs to satisfy the following two necessary conditions. 1. Balance Condition: ∫p(x)w(x′|x)dx=p(x′); and 2. Ergodic Condition: The transition probability between any two states x and x′ is not zero, and it is represented by a product of a finite number of non-zero transition probabilities.

It is commonly difficult to configure the Markov chain that satisfies the balance condition of those necessary conditions. In view of the above, the transition probability is configured by a detailed balance condition, which is a stronger condition.

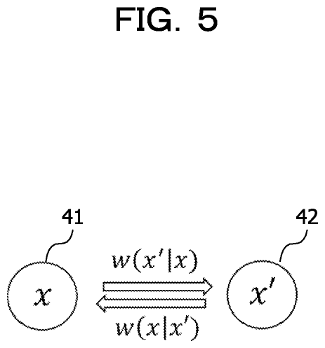

FIG. 5 is a diagram illustrating a transition probability between states. In the detailed balance condition, the transition probability w(X′|X) from the state X to the state X′ and, conversely, the transition probability w(X|X′) from the state X′ to the state X are used. The detailed balance condition is to have the following relationship between those transition probabilities. Detailed Balance Condition: p(x)w(x′|x)=p(x′)w(x|x′)

Examples of an update rule that satisfies such a detailed balance condition include a Metropolis method, a Gibbs sampling method, a hybrid Monte Carlo method (HMC), and the like. For example, according to the Metropolis method, transition is made by the following two steps.
[First Step] Generate x′ according to certain proposal probability distribution g(x′|x)
[Second Step] Accept x′ as a next state with the following acceptance probability A(x′, x)

$$\begin{matrix}[ Mathematical Formula 1 ] & \\ A ( {x}^{′} , x ) = min ( 1 , \frac{p ( {x}^{′} ) g ( x \vert {x}^{′} )}{p ( x ) g ( {x}^{′} \vert x )} ) & ( 1 )\end{matrix}$$

Such transition satisfies the detailed balance condition. Typically, local proposal distribution is used as the proposal probability distribution g(x′|x).

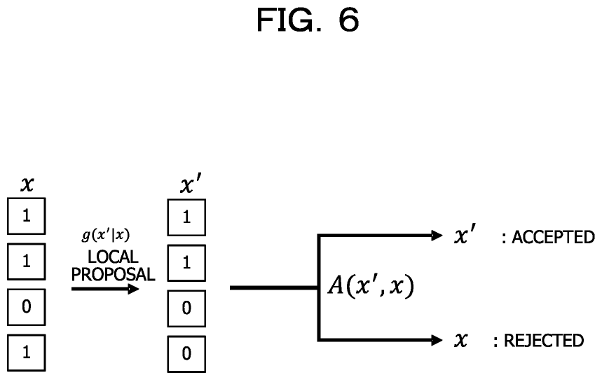

FIG. 6 is a diagram illustrating exemplary local proposal distribution. For example, in a case of a vector including a plurality of elements in which the state x may take a binary of 0 or 1, a dimension (element) of x is randomly selected according to the proposal probability distribution g(x′|x), and the value is inverted. As a result, a state x′ is generated.

It is determined whether or not to accept the generated state x′ according to the acceptance probability A(x′, x). If acceptance is determined, the state transitions to x′. If rejection is determined, the state remains x.

In this manner, according to the Metropolis method, the next state x′ is generated with reference to the previous state x. In a similar manner to the Metropolis method, the previous state is used for transition also in the Gibbs sampling and the HMC. The update rule that satisfies those detailed balance conditions has the following problems.

First, for a specific problem (e.g., multimodal distribution), a probability of transition to a certain state decreases so that transition may not be substantially made, which may lead to a wrong result. Furthermore, for a specific problem (e.g., vicinity of a phase transition point), it continues to stay in a certain local space in the random variable space, and is highly dependent on an initial condition, which makes appropriate sampling impossible.

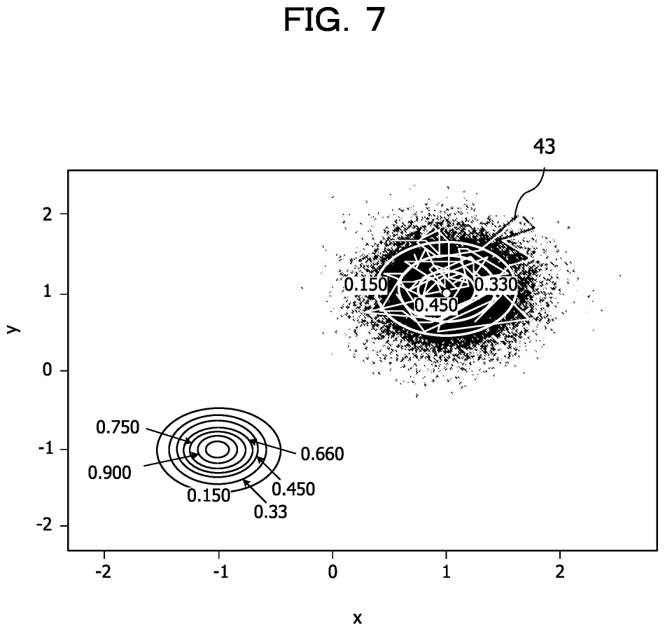

FIG. 7 is a diagram illustrating exemplary improper sampling. FIG. 7 illustrates a sample sequence 43 obtained by performing the Metropolis method on two-dimensional two-component Gaussian distribution. In the example of FIG. 7, the distribution is multimodal, and points indicating a state that may occur in the probability distribution form two clusters. The sample sequence 43 transitions only in one cluster, and fails to transition to the other cluster.

Accordingly, the SLMC that generates, by machine learning, a variational model capable of making global transition has been proposed.

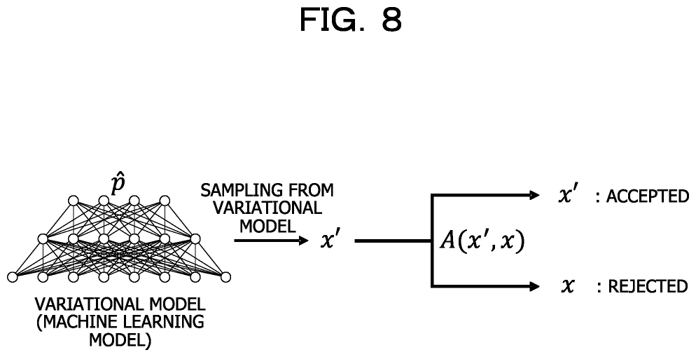

FIG. 8 is a diagram illustrating exemplary sampling by the SLMC. A variational model p (p is attached with \hat{ }) generated by the machine learning outputs a state x′ as a sample when a state x is input. Then, acceptance (transition to x′) or rejection (remain in x) is determined according to an acceptance probability A(x′, x).

For example, when a variational model p(x) (p is attached with \hat{ }) appropriate for proposal probability distribution of the Metropolis method is used, the acceptance probability is expressed by the following equation.

$$\begin{matrix}[ Mathematical Formula 2 ] & \\ A ( {x}^{′} , x ) = min ( 1 , \frac{p ( {x}^{′} ) \hat{p} ( x )}{p ( x ) \hat{p} ( {x}^{′} )} ) & ( 2 )\end{matrix}$$

In the equation (2), the acceptance probability is 1 if p=p (p on the right side is attached with \hat{ }). Furthermore, the previous state is not referred to, whereby global transition is made possible. Moreover, quality of the variational model may be quantitatively evaluated from the acceptance probability.

By using a machine learning model (restricted Boltzmann machine, flow-based model, VAE, etc.) that trains a latent representation as a variational model, it becomes possible to make efficient transition based on training of probability distribution features. This indicates that acquisition of a good latent space leads to efficiency improvement.

In the case of the method using the VAE among the SLMCs using a machine learning model that trains a latent representation as a variational model, the proposal cost of the probability distribution is small, and no strong constraint is imposed on the model to be used.

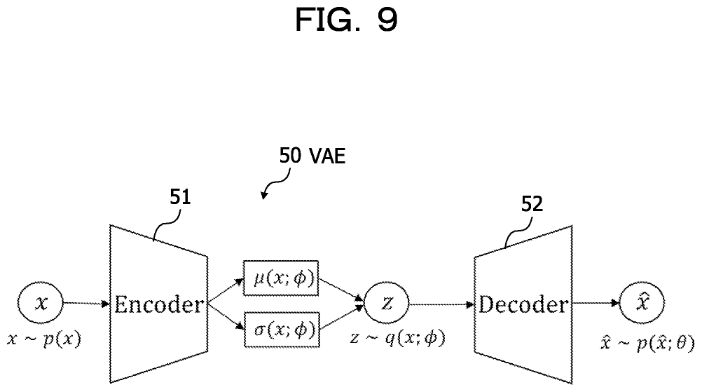

FIG. 9 is a diagram illustrating exemplary sample generation by the VAE. In a case of using a VAE 50, a parameter θ of an encoder 51 and a parameter φ of a decoder 52 are trained by using training data {x_{μ}}^{p}_{μ=1}. As a result, the data probability distribution p(x) is imitated.

Then, when the state x (x to p(x)) according to the probability distribution p(x) is input, the encoder 51 outputs a mean μ(x: φ) and a variance σ(x: φ) according to the state x in the VAE 50. Then, a state z (z to q(x; φ)) is generated according to the probability distribution q(z|x; φ) specified by the mean μ(x: φ) and the variance σ(x: φ) output by the encoder 51. The generated state z is input to the decoder 52, and x (attached with \hat{ }) is generated according to the probability distribution p(x; θ) (x is attached with \hat{ }) of the decoder 52.

It is determined whether or not to accept the generated x (attached with \hat{ }) based on an acceptance probability defined by using a likelihood function. However, in the method using the VAE, the likelihood function is subject to approximate evaluation using the following equation.

$$\begin{matrix}[ Mathematical Formula 3 ] & \\ \hat{p} ( x ; θ ) = \frac{p ( z ) p ( x \vert z ; θ )}{p ( z \vert x ; θ )} \approx \frac{p ( z ) p ( x \vert z ; θ )}{q ( z \vert x ; ϕ )} & ( 3 )\end{matrix}$$

Even if a variational model consistent with a generation model is obtained, the acceptance probability is low when the approximation of the following formula (4) is not appropriate.

[Mathematical Formula 4]

q(z|x;ϕ)≈p(z|x;θ) (4)

When the data is typically complex and high-dimensional, it is difficult to satisfy the formula (4). As described above, even in the method using the VAE, there remains a problem that the acceptance probability is lowered and the sample generation efficiency deteriorates when the approximation is not appropriate. Moreover, it is difficult to quantitatively evaluate the validity of the approximation of the formula (4).

Meanwhile, it has been found that the latent space of the VAE may be transformed into an isometric space as embedding (isometric embedding) having an isometric property by non-linear mapping. The embedding indicates smooth injection (mapping) from a manifold A to a manifold B (both Riemannian manifolds). The isometric property indicates to save an inner product of two minute variations (precisely tangent vectors) on a manifold around a point at a corresponding point of both manifolds after the embedding.

In such isometric embedding, a distance between two pieces of data of the manifold A is equal to a distance between two pieces of data of the manifold B obtained by the injection of those pieces of data. Furthermore, in the isometric embedding, probability density of a point on the manifold A is equal to probability density of a point on the manifold B corresponding to the point.

For example, the latent space of the VAE may be transformed into an isometric space by scaling (scale-up or scale-down) with a value (β/2σj²)^{1/2} different for each data dimension. This is obtained by introducing a variable y satisfying the following equation (5).

$$\begin{matrix}[ Mathematical Formula 5 ] & \\ \frac{\partial {y}_{j}}{\partial {μ}_{j ( x )}} = \frac{\sqrt{\frac{β}{2}}}{{σ}_{j ( x )}} & ( 5 )\end{matrix}$$

Such a variable y is subject to the isometric embedding with respect to the data space of the input data. For example, the probability distribution of y is equivalent to the probability distribution of the data space. For example, the following relationship is established assuming that the probability distribution of the input data in a metric vector space of a metric tensor Gₓ is p_{Gx}(x), the probability distribution of the isometric space is p(y), and the probability distribution of the latent space is p(z).

$$\begin{matrix}[ Mathematical Formula 6 ] & \\ {p}_{{G}_{x}} ( x ) = p ( y ) = p ( z ) \vert det ( \frac{\partial z}{\partial y} ) \vert = p ( z ) {\prod }_{j} \frac{{σ}_{j}}{\sqrt{\frac{β}{2}}} & ( 6 )\end{matrix}$$

In the equation (6), the relationship “p(y)=Πⱼp(yj)=Πⱼ(dyⱼ/dμⱼ₍ₓ₎)⁻¹p(μⱼ)” based on the equation (5) is used. Here, assuming that the probability distribution of the input space coordinates is p(x), the following relationship with the probability distribution p_{Gx}(X) of the metric vector space is established.

[Mathematical Formula 7]

p(x)=p_{Gx}(x)\sqrt{|detGₓ|} (7)

Therefore, from the probability distribution of the latent space, the probability distribution p(x) of the data space of the input data may be derived by the following equation.

$$\begin{matrix}[ Mathematical Formula 8 ] & \\ p ( x ) = p ( z ) \sqrt{\vert det {G}_{x} \vert} {\prod }_{j} \frac{{σ}_{j}}{\sqrt{\frac{β}{2}}} & ( 8 )\end{matrix}$$

Gₓ represents a metric tensor including an error of the VAE. Such a VAE may evaluate a likelihood under a mild condition as in the following formula (9) by performing variable transformation of the probability distribution p(z) (p is attached with \hat{ }) into the probability distribution p(x).

$$\begin{matrix}[ Mathematical Formula 9 ] & \\ \hat{p} ( x ) ∝ {\vert det {G}_{x} \vert}^{\frac{1}{2}} p ( z = μ ( x ; ϕ ) ) {\prod }_{j = 1}^{M} {σ}_{j} ( x ; ϕ ) ∝ {\vert det {G}_{x} \vert}^{\frac{1}{2}} {e}^{- \frac{L ( x )}{β}} & ( 9 )\end{matrix}$$

M represents the number of dimensions of the latent space (space after encoding). L represents an evidence lower bound (ELBO). β represents an adjustable hyperparameter β in a β-VAE. Details of a method of deriving the formula (9) are described in Akira Nakagawa, Keizo Kato, Taiji Suzuki, “Quantitative Understanding of VAE as a Non-linearly Scaled Isometric Embedding”, Proceedings of the 38th International Conference on Machine Learning, PMLR 139:7916-7926, 8-24 Jul. 2021 mentioned above.

When an error of the VAE is represented by a mean squared error (MSE), Gₓ is an identity matrix I. Furthermore, when an error of the VAE is represented by an MSE with a coefficient, Gₓ is “(1/2σ²)I”, for example.

When p=p (p on the right side is attached with \hat{ }) holds for the VAE having a potential isometric property, the acceptance probability is 1 regardless of the validity of the approximation of the formula (4). The VAE may obtain the potential isometric property at an early stage of training, and may quantitatively evaluate the isometric property.

In view of the above, the computer 100 according to the second embodiment carries out sampling by the IVAE-SLMC to achieve efficient sampling.

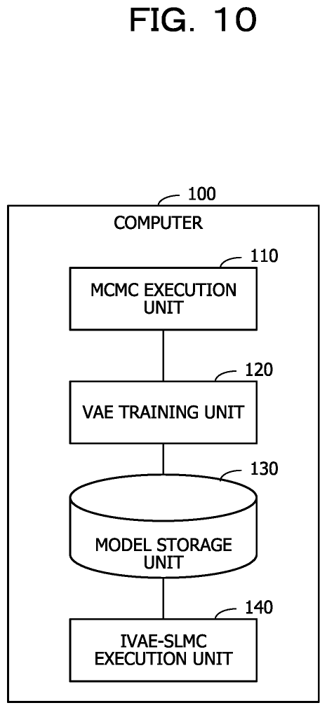

FIG. 10 is a block diagram illustrating exemplary computer functions for the sampling by the IVAE-SLMC. For example, the computer 100 includes an MCMC execution unit 110, a VAE training unit 120, a model storage unit 130, and an IVAE-SLMC execution unit 140.

The MCMC execution unit 110 generates a sample from target probability distribution by using an MCMC different from the IVAE-SLMC. The MCMC execution unit 110 transmits the generated sample to the VAE training unit 120.

The VAE training unit 120 trains the VAE by using the sample generated by the MCMC execution unit 110. By the training of the VAE, a VAE having a potential isometric property is generated as a trained variational model. The VAE training unit 120 stores the generated VAE in the model storage unit 130.

The model storage unit 130 stores the VAE generated by the VAE training unit 120.

The IVAE-SLMC execution unit 140 obtains, from the model storage unit 130, the VAE generated by the VAE training unit 120, and generates a sample based on the IVAE-SLMC using the obtained VAE. Then, the IVAE-SLMC execution unit 140 outputs the generated sample.

Note that the function of each element illustrated in FIG. 10 may be implemented by, for example, causing the computer to execute a program module corresponding to the element.

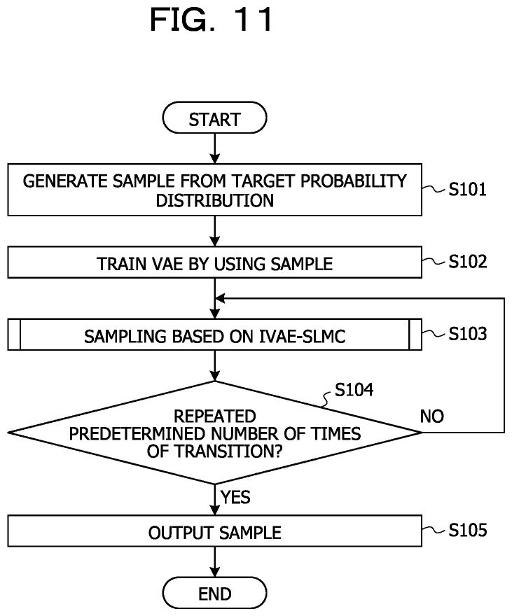

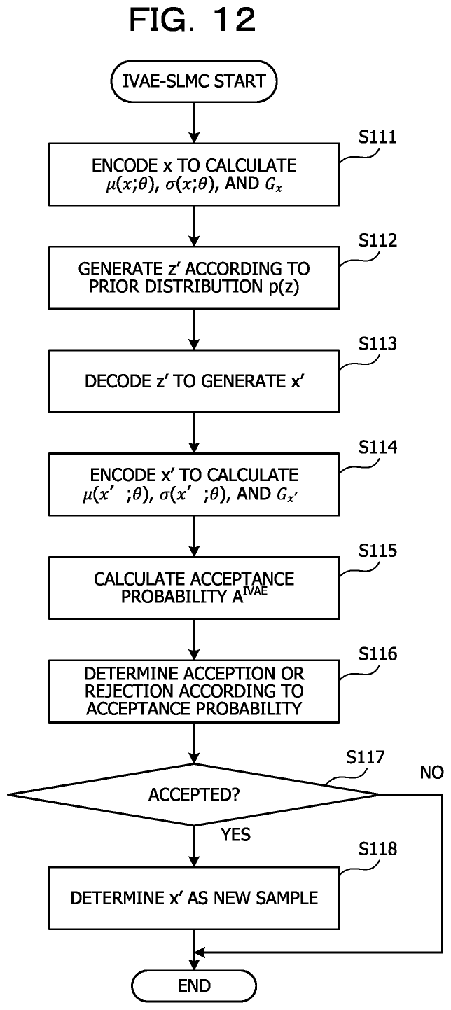

FIG. 11 is a flowchart illustrating an exemplary sample generation process. Hereinafter, the process illustrated in FIG. 11 will be described in accordance with step numbers.

[Step S101] The MCMC execution unit 110 generates a sample from target probability distribution by the MCMC.

[Step S102] The VAE training unit 120 trains a VAE having a potential isometric property based on the sample generated by the MCMC execution unit 110. The VAE training unit 120 stores the trained VAE in the model storage unit 130.

[Step S103] The IVAE-SLMC execution unit 140 executes sampling based on the IVAE-SLMC by using the VAE stored in the model storage unit 130. Details of the sampling based on the IVAE-SLMC will be described later (see FIG. 12).

[Step S104] The IVAE-SLMC execution unit 140 determines whether or not state transition has occurred a predetermined number of times of transition by the IVAE-SLMC execution processing. The number of times of transition is specified by a user in advance. If the state transition has occurred the predetermined number of times of transition, the IVAE-SLMC execution unit 140 advances the process to step S105.

[Step S105] The IVAE-SLMC execution unit 140 outputs the sample generated by the IVAE-SLMC.

Next, a sampling process based on the IVAE-SLMC will be described in detail.

FIG. 12 is a flowchart illustrating an exemplary sampling processing procedure based on the IVAE-SLMC. Hereinafter, the process illustrated in FIG. 12 will be described in accordance with step numbers.

[Step S111] The IVAE-SLMC execution unit 140 encodes the state x by using the encoder of the VAE, and calculates μ(x; θ), σ(x; θ), and Gₓ.

[Step S112] The IVAE-SLMC execution unit 140 generates a state z′ according to prior distribution p(z). For example, the IVAE-SLMC execution unit 140 probabilistically generates the state z′ by making the state more likely to be generated as the probability is higher in the prior distribution p(z).

[Step S113] The IVAE-SLMC execution unit 140 decodes the state z′ by using the decoder of the VAE, and generates a state x′.

[Step S114] The IVAE-SLMC execution unit 140 encodes the state x′ by using the encoder of the VAE, and calculates μ(x′; θ), σ(x′; θ), and Gₓ′.

[Step S115] The IVAE-SLMC execution unit 140 calculates an acceptance probability A^{IVAE} expressed by the following equation (10).

$$\begin{matrix}[ Mathematical Formula 10 ] & \\ {A}^{IVAE} ( {x}^{′} , x ) = min ( 1 , \frac{p ( {x}^{′} ) {\vert det {G}_{x} \vert}^{\frac{1}{2}} p ( z = μ ( x ; θ ) ) {\prod }_{j = 1}^{M} {σ}_{j} ( x ; θ )}{p ( x ) {\vert det {G}_{{x}^{′}} \vert}^{\frac{1}{2}} p ( z = μ ( {x}^{′} ; θ ) ) {\prod }_{j = 1}^{M} {σ}_{j} ( {x}^{′} ; θ )} ) & ( 10 )\end{matrix}$$

Note that, since the acceptance probability is represented by a probability ratio, a normalization constant of the likelihood function may be unknown. The acceptance probability A^{IVAE} is based on the formula (9). The formula (9) is derived from the equation (5) representing a transformation rule from the VAE latent space to the isometric space. Therefore, the acceptance probability A^{IVAE} expressed by the equation (10) is based on the transformation rule from the VAE latent space to the isometric space.

[Step S116] The IVAE-SLMC execution unit 140 determines acceptance or rejection according to the acceptance probability A^{IVAE}. For example, the IVAE-SLMC execution unit 140 generates a random number of a real number of 0 to 1, and determines acceptance if the generated random number is equal to or lower than the acceptance probability A^{IVAE}. Furthermore, the IVAE-SLMC execution unit 140 determines rejection if the generated random number exceeds the acceptance probability A^{IVAE}.

[Step S117] If acceptance is determined, the IVAE-SLMC execution unit 140 advances the process to step S118. Furthermore, if rejection is determined, the IVAE-SLMC execution unit 140 terminates the sampling process based on the IVAE-SLMC.

[Step S118] The IVAE-SLMC execution unit 140 determines the state x′ as a new sample, and stores information indicating the state x′.

In this manner, the state x′ may be generated by using a trained VAE having a potential isometric property, and the generated state x′ may be accepted as the next transition at the acceptance probability A^{IVAE}. In a case of being accepted, the state x′ is saved as a sample. By using the IVAE-SLMC for sampling, an approximate expression does not need to be used for the calculation of the acceptance probability, and generation of effective samples that may be regarded as independent from each other is made efficient.

For example, according to the VAE-SLMC that performs sampling without considering the potential isometric property of the VAE, the acceptance probability is evaluated by using the approximate expression of the likelihood function expressed by the equation (3). Thus, the accuracy of the approximate expression may not be sufficient, and the acceptance probability may be lowered. Furthermore, with the approximate expression used, it is highly likely that, even if a sample is accepted, the sample may not be recognized as an effective sample that may be regarded as independent. On the other hand, according to the IVAE-SLMC, no approximate expression is used for the calculation of the acceptance probability, whereby improvement in generation of an effective sample that may be regarded as independent may be expected.

The sampling efficiency may be evaluated by, for example, the number of effective samples that may be regarded as independent, which are generated when the transition of the Markov chain is performed a predetermined number of times. The number of effective samples that may be regarded as independent is represented by an effective sample size (ESS).

For example, even in the HMC most commonly applied to continuous probability distribution, there are some unsuitable distributions. Examples of such probability distributions include 100d Ill Conditioned Gaussian, 2d Strongly Correlated Gaussian, Banana-shaped Density, Rough Well Density, and the like. Results of sampling based on the HMC and sampling based on the IVAE-SLMC for those probability distributions will be described below.

The number of times of transition of the Markov chain when the HMC and the IVAE-SLMC are compared is “50,000 times”. Furthermore, training data used for the VAE is 10,000 samples generated by the Metropolis method. The ESS used as an evaluation index is the ESS of a first moment and a second moment. Then, as a result of evaluation by the mean value of the ESS of each of the first moment and the second moment in 10 numerical experiments, it has been confirmed that the ESS is significantly improved by the IVAE-SLMC with respect to the probability distribution unsuitable for the HMC.

Furthermore, when the acceptance probabilities of the HMC and the IVAE-SLMC are compared under the same condition, it has also been confirmed that the acceptance probability of the IVAE-SLMC is higher than the acceptance probability of the HMC as the probability distribution is higher-dimensional and more complex.

By performing sampling based on the IVAE-SLMC in this manner, it becomes possible to generate a sample with a high acceptance probability, and it is highly likely that the accepted sample is an effective sample that may be regarded as independent. As a result, appropriate samples are efficiently generated.

### Third Embodiment

A third embodiment is to improve VAE accuracy by performing sequential training of a VAE. For example, when samples output by an IVAE-SLMC execution unit 140 are obtained to some extent, a VAE training unit 120 carries out training of the VAE by using the samples. This improves performance of the VAE as a variational model. With the performance of the VAE improved, sampling efficiency improves.

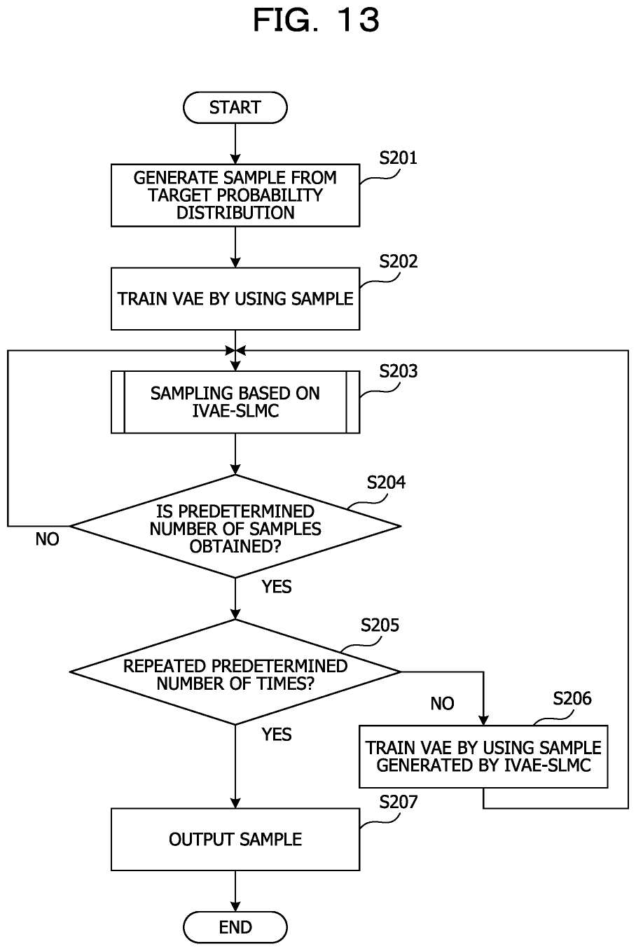

FIG. 13 is a flowchart illustrating an exemplary sample generation process according to the third embodiment. In the process illustrated in FIG. 13, processes in steps S201 to S203 and S207 are similar to the processes in steps S101 to S103 and S105 in the second embodiment illustrated in FIG. 11, respectively. Processing different from that of the second embodiment is the following steps S204 to S206.

[Step S204] The IVAE-SLMC execution unit 140 determines whether or not a predetermined number of samples has been obtained by repeating step S203. For example, the IVAE-SLMC execution unit 140 counts the number of times a generated state x′ is accepted, and determines that the predetermined number of samples has been obtained when the number of times has reached the predetermined number. If the predetermined number of samples has been obtained, the IVAE-SLMC execution unit 140 advances the process to step S205. If the predetermined number of samples has not been obtained, the IVAE-SLMC execution unit 140 advances the process to step S203 to repeat sampling based on the IVAE-SLMC.

[Step S205] The IVAE-SLMC execution unit 140 determines whether or not VAE training processing in step S202 has been repeated a predetermined number of times. If the VAE training processing in step S202 has been repeated the predetermined number of times, the IVAE-SLMC execution unit 140 advances the process to step S207. Furthermore, if the VAE training processing in step S202 has not been repeated the predetermined number of times, the IVAE-SLMC execution unit 140 advances the process to step S206.

[Step S206] The VAE training unit 120 trains the VAE by using the samples generated by the IVAE-SLMC (excluding the samples already used for the VAE training). After the training of the VAE, the VAE training unit 120 advances the process to step S203.

In this manner, when the number of samples generated by the IVAE-SLMC reaches the predetermined number, the VAE training is carried out by using the samples. As a result, the VAE accuracy improves, and the sampling efficiency of the IVAE-SLMC also improves.

### Fourth Embodiment

A fourth embodiment is to execute an IVAE-SLMC in parallel. By executing the IVAE-SLMC in parallel, it becomes possible to perform sequential training by using all samples obtained by parallel sampling. As a result, a VAE with higher performance may be obtained as a variational model.

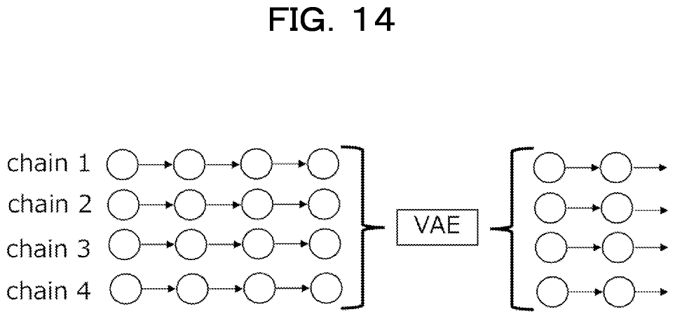

FIG. 14 is a diagram illustrating exemplary parallel execution of the IVAE-SLMC. For example, a computer 100 includes a plurality of processors 101 (or processor cores), and executes the IVAE-SLMC in parallel for each processor. Furthermore, the IVAE-SLMC may be processed in parallel by a plurality of computers coupled via a network.

In FIG. 14, the IVAE-SLMCs (processing of step S203 in FIG. 13) to be executed in parallel are set as “chain 1” to “chain 4”, respectively. When a predetermined number of samples have obtained in each of the “chain 1” to “chain 4”, VAE training is carried out by using the obtained samples. Then, the IVAE-SLMC is executed in parallel by using the trained VAE.

Since each of the “chain 1” to “chain 4” executed in parallel is performed independently, a large number of effective samples may be generated. Thus, it becomes possible to obtain a large number of samples suitable for training, and the VAE with higher performance may be efficiently trained as a variational model.

### Fifth Embodiment

A fifth embodiment is to select a dimension to be projected to a latent space at a time of compression to a lower dimension based on samples obtained by an IVAE-SLMC. In Bayesian statistics and natural science, principal component analysis or the like may be carried out to understand a structure of probability distribution from generated samples. In the principal component analysis, a process is performed in the following procedures.
<First Step> Acquisition of samples by an appropriate MCMC
<Second Step> Execution of the principal component analysis for the obtained samples
<Third Step> Selection of a principal component having a large contribution degree, and projection of the selected principal component to a principal component space

By using a VAE having a potential isometric property as a variational model, it becomes possible to carry out similar low-dimensional compression at low cost without performing the principal component analysis. For example, variance of each dimension of a latent variable having a potential isometric property represents importance of the corresponding dimension. Thus, the importance (importanceⱼ) of the j-th dimension of the latent space may be calculated by the equation (11) by using an expectation value (E[ ]) of the variance of the corresponding dimension.

$$\begin{matrix}[ Mathematical Formula 11 ] & \\ {Importance}_{j} = \frac{β}{2} {𝔼}_{x ∼ p ( x )} [ {{σ}_{j} ( x ; θ )}^{- 2} ] & ( 11 )\end{matrix}$$

As the value of the importance obtained by the equation (11) is larger, the importance of the dimension increases in the low-dimensional compression. The dimensional compression at low cost is made possible by, using the VAE obtained by the IVAE-SLMC, evaluating the importance, selecting a latent space with a large degree of importance, and performing dimensional compression to a low-dimensional region.

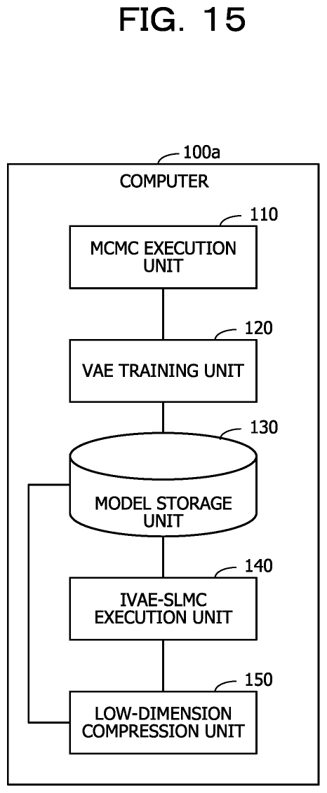

FIG. 15 is a block diagram illustrating exemplary computer functions according to the fifth embodiment. In FIG. 15, elements having functions same as those in the second embodiment are denoted by the same reference numerals, and description thereof will be omitted. A computer 100a according to the fifth embodiment includes a low-dimension compression unit 150 in addition to functions (see FIG. 10) similar to those of the computer 100 according to the second embodiment.

The low-dimension compression unit 150 calculates importance of each dimension representing a state x by using the VAE obtained by the VAE training unit 120, and performs dimensional compression on a dimension selected according to the importance.

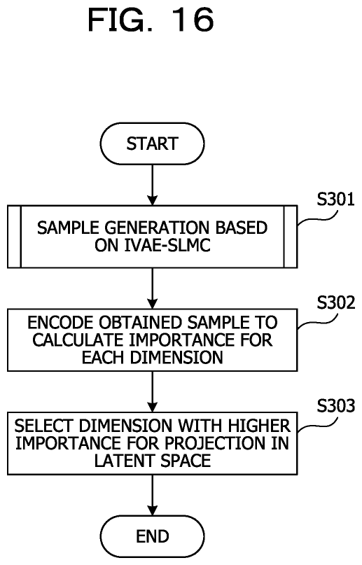

FIG. 16 is a flowchart illustrating an exemplary procedure of the low-dimensional compression process. Hereinafter, the process illustrated in FIG. 16 will be described in accordance with step numbers.

[Step S301] The MCMC execution unit 110, the VAE training unit 120, and the IVAE-SLMC execution unit 140 cooperate to perform a sample generation process based on the IVAE-SLMC. Details of this process are as illustrated in FIGS. 11 and 12.

[Step S302] The low-dimension compression unit 150 encodes samples generated in step S301 with the VAE trained by the VAE training unit 120, and calculates importance for each dimension using the equation (7).

[Step S303] The low-dimension compression unit 150 selects a predetermined number of dimensions in descending order of the importance, and projects the selected dimensions in the latent space.

In this manner, the low-dimensional compression is performed on the important dimension. In the process illustrated in FIG. 16, the principal component analysis of the samples is not needed. The calculation amount of the principal component analysis is much larger than that of the calculation of the importance expressed by the equation (7). Thus, according to the fifth embodiment, the calculation amount may be significantly reduced.

### Other Embodiments

In the second embodiment, the following formula is used as the likelihood in the equation (10) of the acceptance probability A^{VAE}.

$$\begin{matrix}[ Mathematical Formula 12 ] & \\ \hat{p} ( x ) ∝ {\vert det {G}_{x} \vert}^{\frac{1}{2}} p ( z = μ ( x ; ϕ ) ) {\prod }_{j = 1}^{M} {σ}_{j} ( x ; ϕ ) & ( 12 )\end{matrix}$$

This likelihood may also be calculated by the following formula as expressed in the formula (9).

$$\begin{matrix}[ Mathematical Formula 13 ] & \\ \hat{p} ( x ) ∝ {\vert det {G}_{x} \vert}^{\frac{1}{2}} {e}^{- \frac{L ( x )}{β}} & ( 13 )\end{matrix}$$

For example, there are two variations in the calculation of the acceptance probability. The calculation results of the acceptance probability using the formula (12) and the acceptance probability using the formula (13) are not completely the same, and a slight error occurs. In view of the above, the IVAE-SLMC execution unit 140 may obtain a formula by which the acceptance probability is made higher in advance, and may calculate the acceptance probability by using the corresponding formula.

While the embodiments have been exemplified thus far, the configuration of each unit illustrated in the embodiments may be replaced with another configuration having a similar function. Furthermore, any other components and steps may be added. Moreover, any two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a sampling process comprising:
converting first data in a latent space into second data in a data space by using a machine learning model that has the latent space transformable into an isometric space with same probability distribution as the data space according to a predetermined transformation rule;
determining whether or not to accept the second data as a transition state in a Markov chain Monte Carlo method from an accepted first sample in the data space with an acceptance probability based on the transformation rule; and
outputting the second data as a second sample of the transition state from the first sample when the second data is determined to be accepted.

2. The non-transitory computer-readable recording medium according to claim 1, wherein
the converting into the second data uses a variational autoencoder (VAE) as the machine learning model, and decodes the first data with a decoder of the VAE to convert the first data into the second data.

3. The non-transitory computer-readable recording medium according to claim 2, wherein
the determining whether or not to accept the second data is configured to:
encode the first sample with an encoder of the VAE to calculate a first mean value, a first variance, and a first metric tensor;
encode the second data with the encoder of the VAE to calculate a second mean value, a second variance, and a second metric tensor; and
calculate the acceptance probability based on the first mean value, the first variance, the first metric tensor, the second mean value, the second variance, and the second metric tensor.

4. The non-transitory computer-readable recording medium according to claim 1, the recording medium storing the program for causing the computer to execute the sampling process further comprising:
executing training of the machine learning model by using the second sample.

5. The non-transitory computer-readable recording medium according to claim 1, the recording medium storing the program for causing the computer to execute the sampling process further comprising:
executing, in parallel, a sampling process that includes the converting into the second data, the determining whether or not to accept the second data, and the accepting the second data as the second sample with each of a plurality of processors; and
executing training of the machine learning model by using the second sample accepted by each of the plurality of processors.

6. A sampling method comprising:
converting first data in a latent space into second data in a data space by using a machine learning model that has the latent space transformable into an isometric space with same probability distribution as the data space according to a predetermined transformation rule;
determining whether or not to accept the second data as a transition state in a Markov chain Monte Carlo method from an accepted first sample in the data space with an acceptance probability based on the transformation rule; and
outputting the second data as a second sample of the transition state from the first sample when the second data is determined to be accepted.

7. An information processing apparatus comprising:
a memory; and
a processor coupled to the memory and configured to:
convert first data in a latent space into second data in a data space by using a machine learning model that has the latent space transformable into an isometric space with same probability distribution as the data space according to a predetermined transformation rule;
determine whether or not to accept the second data as a transition state in a Markov chain Monte Carlo method from an accepted first sample in the data space with an acceptance probability based on the transformation rule; and
output the second data as a second sample of the transition state from the first sample when the second data is determined to be accepted.
